(19) United States
(12) Patent Application Publication
(10) Pub. No.: US 2006/0050519 A1
(43) Pub. Date: Mar. 9, 2006

(54) Multi angles extending desk lamp

(76) Inventor: Jack Lin, Taoyuan Hsien (TW)

Correspondence Address: Yi-Wen Tseng, 4331 Stevens Battle Lane, Fairfax, VA, 22033, US

(21) Appl. No.: 10/934,590

(22) Filed: Sep. 3, 2004

(51) Int. Cl. F21S 8/08

(52) U.S. Cl. 362/413; 362/419

(57) ABSTRACT

A multi angles extending desk lamp, which includes a lamp head, an extending lamp body, and a lamp stand. The lamp head has a first contact surface which has a connecting port formed in its center. The extending lamp body has a second contact surface and a third contact surface. Both the second and the third contact surface have a pivotal connecting port. The lamp stand has a fourth contact surface which has a connecting port. The pivotal connecting port of the second contact surface connects to the connecting port of the first contact surface while the pivotal connecting port of the third contact surface connects to the connecting port of the fourth contact surface. The multi angles extending desk lamp is capable of multi directional illumination through the angular variation of both the lamp head and the extending lamp body. Further, stable orienting structures are formed at the junctures between the various components.

### BACKGROUND OF THE INVENTION

The present invention relates in general to a desk lamp, and more particularly, to a multi angles, rotational extending desk lamp, which is capable of changing its illuminating area through the rotation of the extending lamp body or the lamp head thereof.

The desk lamp has been widely utilized in the daily life of consumers since its invention. It has become a necessity for modern life. But, in the present market consumers do not have many choices in regarding to desk lamps, because the conventional design of the desk lamp is focused on appearance rather than on functionality. In contrast, the present invention focuses on the functionality of the desk lamp.

Taiwan utility model patent number 388486 discloses a conventional desk lamp structure. It includes, generally, a lamp head, a lamp rod, and a lamp stand. The conventional lamp is capable of varying its area of illumination through the utilization of the two ends of the lamp rod which is pivotally connected to both the lamp head and the lamp stand. However, this invention is composed of a number of elements. Because it is composed of a number of elements, its structure is complicated and the cost of the die and the material are high. The assembling and installation of this invention is also time consuming. The manufacturing cost is, therefore, unable to be effectively reduced. Further, both the connection between the lamp head and the lamp rod and the connection between the lamp rod and the lamp stand are secured by screws or other implements. The lamp head and the lamp rod are likely to fall down during use because of the conventional lamp's instability. When that happens, a consumer has to tighten the screw elements in order to reorient the lamp head and the lamp rod. But, the process of reorientation must be repeated later since the screw elements seldom will remain tightened. In sum, the aforementioned conventional desk lamp structure is also inconvenient for consumer use.

### BRIEF SUMMARY OF THE INVENTION

The present invention provides a rotational multi angles extending desk lamp, which is capable of multi directional illumination through the angular variation of both the lamp head and the extending lamp body thereof. Further, stable orienting structures are formed at the junctures between the various components.

Accordingly, the desk lamp provided by the present invention includes a lamp head, an extending lamp body, and a lamp stand. The lamp head has one end formed as a first beveled surface with a first connecting port located thereon. The extending lamp body has one end formed as a second beveled surface contacted to the first beveled surface with a second connecting port pivotally engaged to the first connecting port located thereon, and the other end formed as a third beveled surface with a third connecting port formed thereon. The lamp stand has one end formed as a fourth beveled surface contacted to the third beveled surface with a fourth connecting port pivotally engaged to the third connecting port located thereon. The multi angles extending desk lamp is capable of multi directional illumination through the angular variation of both the lamp head and the extending lamp body.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 is an exploded view of a multi angles extending desk lamp of the present invention.

FIG. 2 is perspective view of a multi angles extending desk lamp when ready for storage.

FIG. 3 is a cross-sectional view of a multi angles extending desk lamp of the present invention.

FIG. 4 is another cross-sectional view of a multi angles extending desk lamp of the present invention showing a condition that the lamp head has changed its direction.

FIG. 5 is still another cross-sectional view of a multi angles extending desk lamp of the present invention showing a condition that both the lamp head and the extending lamp body has changed their direction.

FIG. 6 is yet another cross-sectional view of a multi angles extending desk lamp of the present invention showing a condition that the extending lamp body has changed its length.

FIG. 7 is perspective view of a multi angles extending desk lamp of another embodiment of the present invention when ready for storage.

FIG. 8 is rear perspective view of a multi angles extending desk lamp of another embodiment of the present invention when ready for use.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

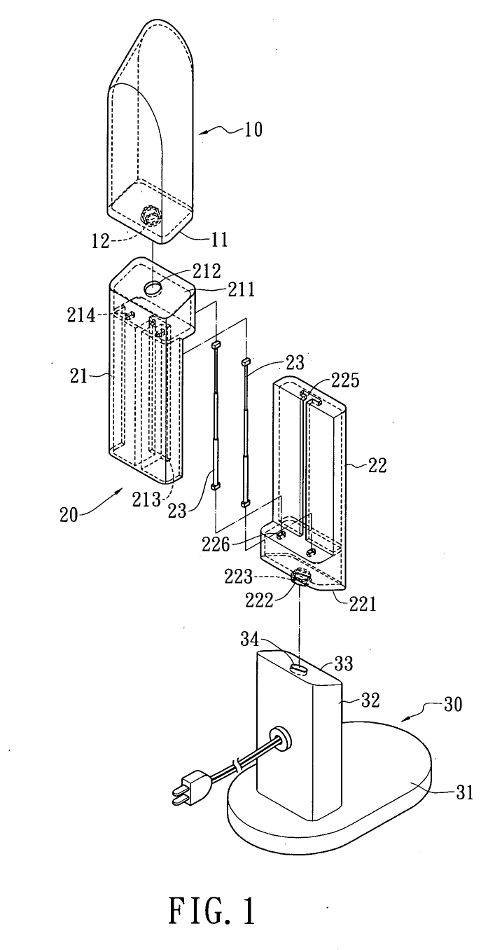

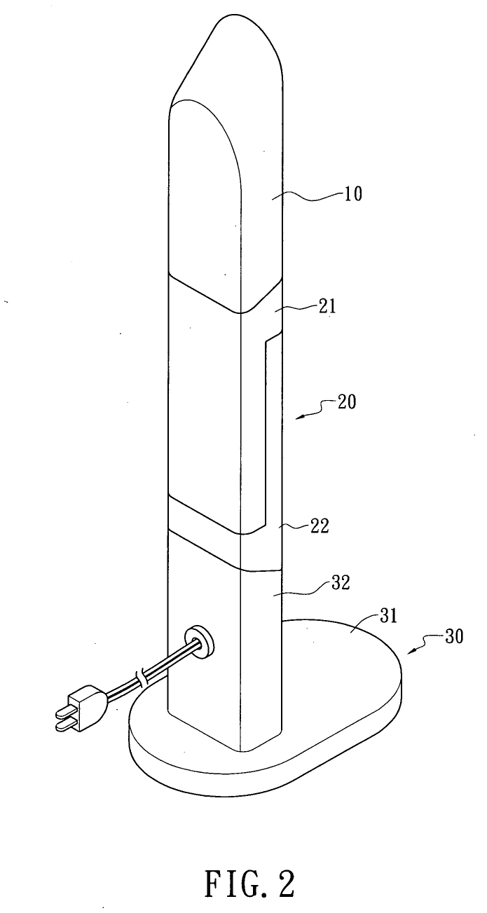

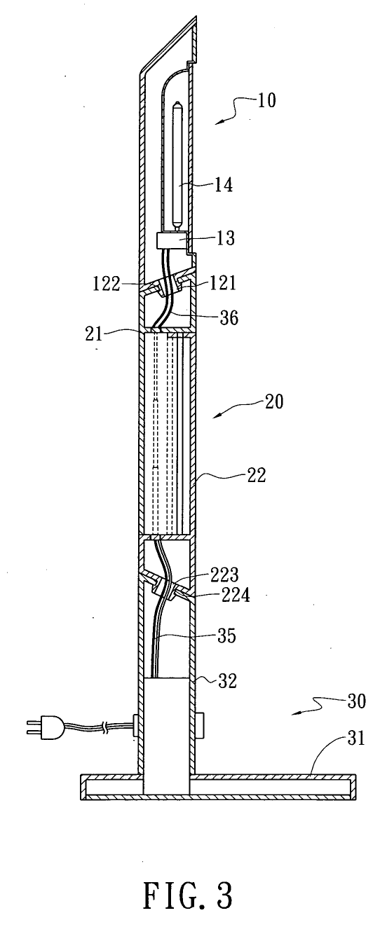

Referring to FIG. 1 through FIG. 3, an exploded view, a perspective view, and a cross sectional view of the present invention are shown respectively. The multi angles extending desk lamp includes, basically, a lamp head 10, an extending lamp body 20, and a lamp stand 30. The lamp head 10 can be made from plastic or other material. The lamp head 10 has a first contact surface 11 formed on one end thereof. The first contact surface 11 has a connecting port 12 which is formed in the center thereof. The connecting port 12 may be configured as a barrel shaft or a circular hole. The connecting port 12 of the present embodiment is configured as a barrel shaft. The connecting port 12 has a thread through hole 121 bored at its center, and an annular concave groove 122 around its circumference. In addition, a bulb socket 13 and a light bulb 14 which is inserted into the bulb socket 13 are secured inside the lamp head 10.

The extending lamp body 20 is composed of an upper rail housing 21 and a lower track housing 22. The extending lamp body 20 may also be made from plastic or other material. The upper rail housing 21 has a second contact surface 211 formed on the top thereof. The second contact surface 211 is assembled with the corresponding first contact surface 11. Further, the second contact surface 211 has a pivotal connecting port 212 bored at the center thereof. The pivotal connecting port 212 correspondingly connects to the connecting port 12 of the first contact surface 11. The pivotal connecting port 212 can be configured as a barrel shaft or a circular hole. The pivotal connecting port 212 of the present embodiment is a circular hole in shape. The inner diameter of the pivotal connecting port 212 corresponds with the outer diameter of the concave grove 122 of the connecting port 12. In addition, the upper rail housing 21 has a longitudinal T-shaped guide rail 213 protruding from the inner side thereof. The T-shaped guide rail 213 has slot holes 214 on both its sides.

The lower track housing 22 has a third contact surface 221 formed at the bottom thereof. The third contact surface 221 has a pivotal connecting port 222 formed at the center thereof. The pivotal connecting port 222 can be a barrel shaft or a circular hole in configuration. The pivotal connecting port 222 of the present embodiment is configured as a barrel shaft. A thread through hole 223 is formed at the center of the pivotal connecting port 222. An annular concave groove 224 is formed around the circumference of the pivotal connecting port 222. In addition, the lower track housing 22 has a guide track 225 formed inside which corresponds to the guide rail 213 of the upper rail housing 21. The guide rail 213 and the guide track 225 enable the upper rail housing 21 to extend upward or downward on the lower track housing 22. The lower track housing 22 has two slot holes 226 bored on both its sides. An electricity conducting rod 23 which is extendable has one end installed into the slot hole 214 of the upper rail housing 21 and its other end installed into the slot hole 226 of the lower track housing 22.

The lamp stand 30 includes a base mount 31 and a supporting stand 32 extending upward from the base mount 31. The supporting stand 32 has a fourth contact surface 33 formed at the top thereof. The fourth contact surface 33 is assembled with the corresponding third contact surface 221 of the extending lamp body 20. A connecting port 34 which is disposed on the fourth contact surface 33 connects to the pivotal connecting port 222 of the third contact surface 221. The connecting port 34 may be configured as a barrel shaft or a circular hole. The connecting port 34 of the present embodiment is configured as a circular hole. The inner diameter of the connecting port 34 corresponds with the outer diameter of the concave groove 22 of the pivotal connecting port 222. Additionally, a transformer, which is not shown in the figures, is installed inside the base mount 31 in order to reduce the external input voltage to the low 12V output. The output end of the transformer connects to an electric wire 35, which first passes through the inner space of the supporting stand 32 and then through the lower track housing 22, finally electrically connects to one end of the conducting rod 23. The other end of the conducting rod 23 connects to another electric wire 36, which passes through the inner space of the upper rail housing 21 and then through the lamp head 10, finally electrically connects to the lamp socket 13.

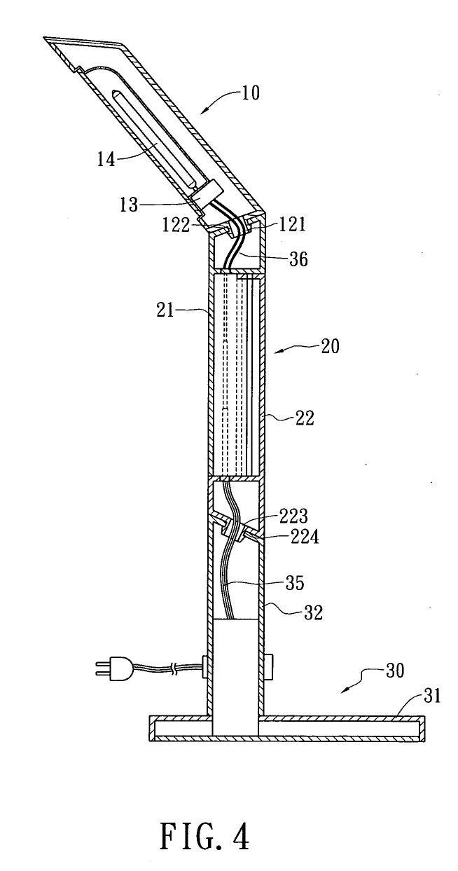

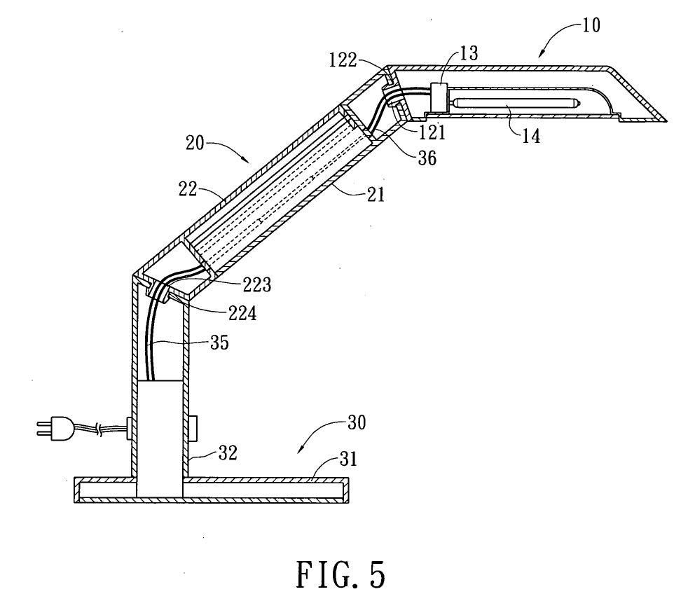

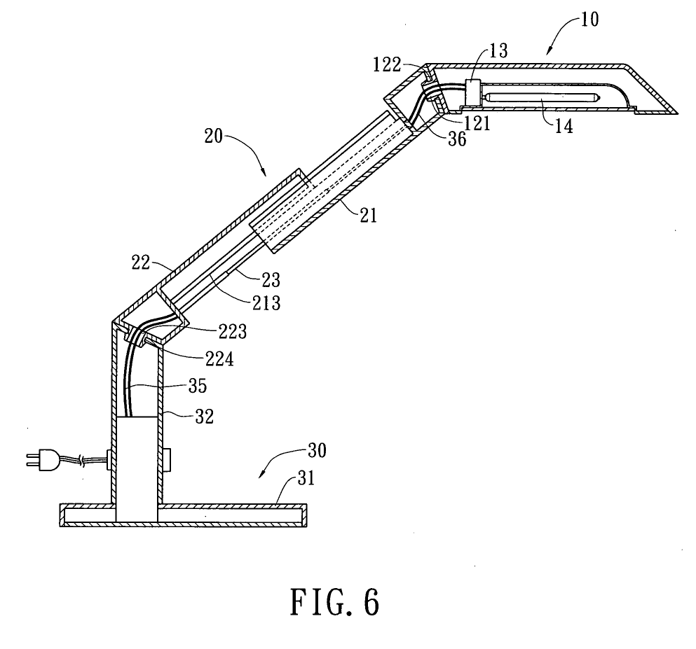

Referring to FIG. 4 through FIG. 6, three cross-sectional views are illustrated respectively; the condition that the lamp head 10 has changed its direction, the condition that both the lamp head 10 and the extending lamp body 20 have changed their directions, and the condition that the extending lamp body 20 has changed its length. By utilizing the aforementioned members, a consumer can rotate the lamp head 10 by 180 degrees, and thereby, switch the lamp head 10 from vertical position into an angled position in order to provide a sloping illumination. After adjusting the lamp head 10, the consumer can also rotate the lamp body 20 by 180 degrees. This rotation of the lamp body 20 will further change the lamp head 10 to a lateral position. Furthermore, the desk lamp is capable of changing its illuminating position and scope by utilizing the extending lamp body 20, as illustrated in FIG. 6.

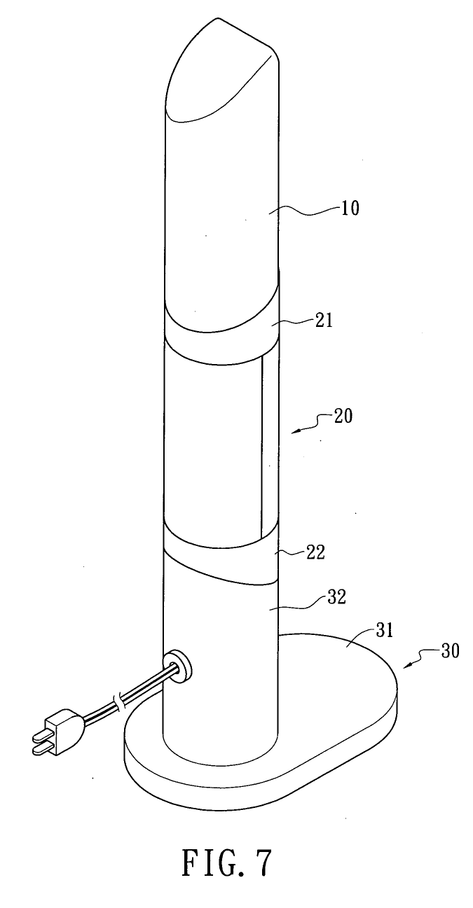

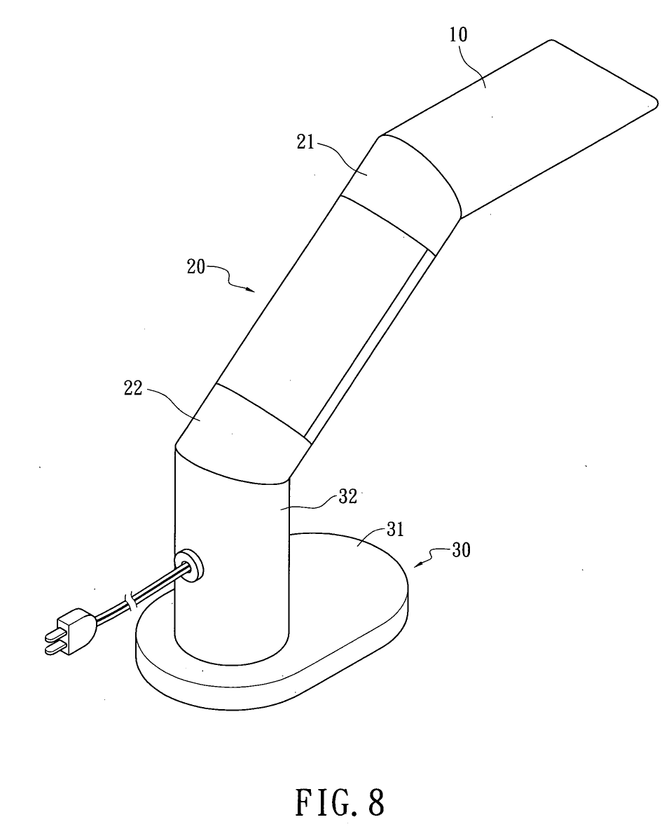

Referring to FIG. 7 and FIG. 8, two perspective views illustrate another embodiment of the present invention. In this embodiment, the lateral cross-section of the lamp head 10, the extending lamp body 20, and the supporting stand 32 of the lamp stand 30 may be configured as a rectangular, a trapezoid, a circle, a semi circle, or any possible geometric shape. In the present embodiment, the cross-section of the aforementioned members of the desk lamp is a circle, which is not only convenient for consumers to grasp, rotate, and change the illuminating direction, but is also easy for consumers who wish to give the lamp an attractive configuration.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A desk lamp comprising:
a lamp head having one end formed as a first beveled surface with a first connecting port located thereon;
an extending lamp body having one end formed as a second beveled surface contacted to the first beveled surface with a second connecting port pivotally engaged to the first connecting port located thereon, and the other end formed as a third beveled surface with a third connecting port formed thereon; and
a lamp stand having one end formed as a fourth beveled surface contacted to the third beveled surface with a fourth connecting port pivotally engaged to the third connecting port located thereon;
whereby a illuminating area providing by the lamp head can be changed through the rotation of the extending lamp body or the lamp head.

2. The desk lamp of claim 1, wherein the first connecting port is configured as a barrel shaft while the second connecting port is shaped as a circular hole.

3. The desk lamp of claim 2, wherein a thread through hole is formed in the center of the first connecting port for an electric wire to pass through.

4. The desk lamp of claim 2, wherein a concave groove is formed around the circumference of the barrel shaft, an outer diameter of the concave groove corresponds to an inner diameter of the circular hole.

5. The desk lamp of claim 1, wherein the first connecting port is configured as a circular hole while the second pivotal connecting port is shaped as a barrel shaft.

6. The desk lamp of claim 1, wherein the third is configured as a barrel shaft while the fourth connecting port is shaped as a circular hole.

7. The desk lamp of claim 6, wherein a thread through hole is formed in the center of the barrel shaft for an electric wire to pass through.

8. The desk lamp of claim 6, wherein a concave groove is formed around the circumference of the barrel shaft, and an outer diameter of the concave groove corresponds with an inner diameter of the circular hole.

9. The desk lamp of claim 1, wherein the third connecting port is configured as a circular hole while the fourth connecting port is shaped as a barrel shaft.

10. The desk lamp of claim 1, wherein the extending lamp body further comprises an upper rail housing and a lower track housing slidably engaged to each other, and the second beveled surface is formed on the top end of the upper rail housing while the third beveled surface is formed on the bottom end of the lower track housing so that the illuminating area can be changed through an extension of the extending lamp body by sliding away the upper rail housing and the lower track housing.

11. The desk lamp of claim 10, wherein a plurality of electricity conducting rod are disposed between the upper rail housing and the lower track housing, and the conducting rods are electrically connected to an electric wire.

12. The desk lamp of claim 10, wherein the upper rail housing has a guide rail while the lower track housing has a corresponding guide track, the guide rail and the guide track enabling the upper rail housing to extend upward or downward on the lower track housing.
